(19) United States
(12) Patent Application Publication
(10) Pub. No.: US 2021/0365239 A1
(43) Pub. Date: Nov. 25, 2021

(54) LOGARITHM CALCULATION METHOD AND LOGARITHM CALCULATION CIRCUIT

(71) Applicant: Realtek Semiconductor Corp., HsinChu (TW)

(72) Inventors: Boya Zhao, Suzhou City (CN); Dong Qiu, Suzhou City (CN); Mingzhe Tang, Suzhou City (CN); Yan Wu, Suzhou City (CN)

(21) Appl. No.: 17/184,625

(22) Filed: Feb. 25, 2021

(30) Foreign Application Priority Data
May 25, 2020 (CN) 202010446312.0

(51) Int. Cl. G06F 7/483; G06F 7/485; G06F 7/487; G06F 5/01

(52) U.S. Cl. CPC G06F 7/4833; G06F 5/01; G06F 7/4876; G06F 7/485

(57) ABSTRACT

The present invention provides a logarithm calculation method, wherein the logarithm calculation method includes the steps of: (a) selecting a first parameter, a second parameter, a third parameter and a fourth parameter corresponding to an i-th iteration operation; (b) determining whether an input value is greater than the third parameter or smaller than the fourth parameter (c) if the input value is greater than the third parameter, updating the input value by multiplying the first parameter, and updating an output value by subtracting a logarithmic value of the first parameter; if the input value is less than the fourth parameter, updating the input value by multiplying the second parameter, and updating the output value by subtracting a logarithmic value of the second parameter (d) adding one to ‘i’ and return to step (a); (e) when ‘i’ is equal to a predetermined value, outputting the current output value.

### BACKGROUND OF THE INVENTION

### 1. Field of the Invention

The present invention relates to a logarithm calculation method.

### 2. Description of the Prior Art

In a conventional logarithm calculation circuit, a coordinate rotation digital computer (CORDIC) is usually used to achieve logarithm calculations. However, the above method needs to store a large parameter table, and also need to use many multipliers with complicated circuit designs. Therefore, it will increase the complexity and cost of the circuit design.

### SUMMARY OF THE INVENTION

It is therefore an objective of the present invention to provide a logarithm calculation method and related circuits, which only need two addition operations and one shift operation in each iteration operation, so the circuit design can be greatly simplified to solve the problems in the prior art.

According to one embodiment of the present invention, a logarithm calculation method for performing a logarithm operation on an initial input value is disclosed. The logarithm calculation method comprises the steps of: (a) selecting a first parameter, a second parameter, a third parameter and a fourth parameter corresponding to an i-th iteration operation; (b) determining whether an input value is greater than the third parameter, or smaller than the fourth parameter, or between the third parameter and the fourth parameter, wherein the input value is obtained by the initial input value; (c) if the input value is greater than the third parameter, updating the input value by multiplying the first parameter, and updating an output value by subtracting a logarithmic value of the first parameter; if the input value is less than the fourth parameter, updating the input value by multiplying the second parameter, and updating the output value by subtracting a logarithmic value of the second parameter; and if the input number is between the third parameter and the fourth parameter, not changing the input value and output value; (d) adding one to the value ‘i’ and return to step (a) until the value ‘i’ is equal to a predetermined value; and (e) when the value ‘i’ is equal to the predetermined value, using the current output value as a calculation result of the logarithm operation of the initial input value.

According to one embodiment of the present invention, a logarithm calculation circuit for performing a logarithm operation on an initial input value is disclosed. The logarithm calculation circuit comprises an iteration operation circuit, for performing multiple iteration operations in sequence, wherein for any iteration operation performed by the iteration operation circuit, the iteration operation circuit performs the following operations: (a) selecting a first parameter, a second parameter, a third parameter and a fourth parameter corresponding to an i-th iteration operation; (b) determining whether an input value is greater than the third parameter, or smaller than the fourth parameter, or between the third parameter and the fourth parameter, wherein the input value is obtained by the initial input value; (c) if the input value is greater than the third parameter, updating the input value by multiplying the first parameter, and updating an output value by subtracting a logarithmic value of the first parameter; if the input value is less than the fourth parameter, updating the input value by multiplying the second parameter, and updating the output value by subtracting a logarithmic value of the second parameter; and if the input number is between the third parameter and the fourth parameter, not changing the input value and output value; (d) using the updated input value and the updated output value as the input value and the output value of the next iteration operation; wherein the output value generated by the last iteration operation of the iteration operation circuit is used as a calculation result of the logarithm operation of the initial input value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a logarithm calculation method according to one embodiment of the present invention.

FIG. 2 is a diagram illustrating a logarithm calculation circuit according to one embodiment of the present invention.

### DETAILED DESCRIPTION

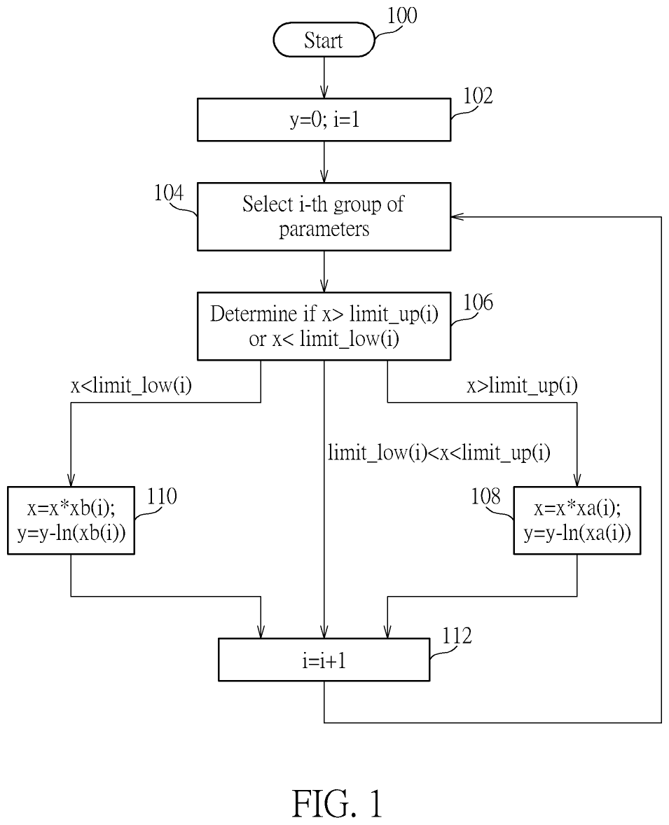

FIG. 1 is a flowchart of a logarithm calculation method according to one embodiment of the present invention. As shown in FIG. 1, in Step 100, the flow starts, and an initial input value x is prepared to perform a logarithm operation to obtain an output value y, that is, y=ln(x). In Step 102, the output value y is set to 0, and a parameter i is set to 1 (that is, the first iteration operation is performed), and the initial input value x is converted into a floating-point number, that is the initial input value x is converted to x=m*2\hat{ }n, where n is a positive integer and m is a value between 0.5 and 1. In one embodiment, m can be a 16-bit digital value, and n can be a 6-bit digital value. In step 104, the i-th group of parameters are selected, where the i-th group of parameters includes xa(i), xb(i), limit_up(i), limit_low(i), at this time, since i is equal to 1, the xa(1), xb(1), limit_up(1), limit_low(1) in the first group of parameters are (1/2), (3/2), (4/3), (4/5), respectively. In Step 106, it is determined if the initial input value x is larger than the parameter limit_up(1) or smaller than the parameter limit_low(1). If the initial input value x is greater than the parameter limit_up(1), the flow enters Step 108; if the initial input value x is less than the parameter limit_low(1), the flow enters Step 110; and if the initial input value x is between the parameters limit_up(1) and limit_low(1), the flow enters Step 112. In Step 108, the initial input value x is updated by multiplying the parameter xa(1) (hereafter, the subsequent x is called the input value), and the output value y is updated by subtracting ln(xa(1)), that is x=x*xa(1), and y=y-ln(xa(1)). In Step 110, the input value x is updated by multiplying the parameter xb(1), and the output value y is updated by subtracting ln(xb(1)), that is, x=x*xb(1) and y=y-ln(xb(1)). In step 112, the parameter i is updated by adding one, and the flow goes back to Step 104 to start the second iteration operation.

It should be noted that since the above parameters xa(1) and xb(1) satisfy the conditions of 1−2\hat{ }(−1) and 1+2\hat{ }(−1) respectively, therefore, the calculation x*xa(1) in Step 108 can be implemented by a shift register and an adder in a circuit design, that is, x*xa(1)=x*(1−2\hat{ }(−1))=x−x>>1, where “>>” is a shift operator. Similarly, the calculation x*xb(1) in Step 110 can be implemented by a shift register and an adder in a circuit design, that is, x*xb(1)=x*(1+2\hat{ }(−1))=x+x>>1, where “>>” is the shift operator.

In the second iteration operation, the parameters xa(2), xb(2), limit_up(2), limit_low(2) included in the second group of parameters and selected in Step 104 are (3/4), (5/4), (8)/7), (8/9), respectively. In Step 106, it is determined that if the initial input value x is larger than the parameter limit_up(2) or smaller than the parameter limit_low(2). If the initial input value x is greater than the parameter limit_up(2), the flow enters Step 108; if the initial input value x is less than the parameter limit_low(2), the flow enters Step 110; and if the initial input value x is between the parameters limit_up(2) and limit_low(2), the flow enters Step 112. In Step 108, the input value x is updated by multiplying the parameter xa(2), and the output value y is updated by subtracting ln(xa(2)), that is x=x*xa(2), and y=y−ln(xa(2)). In Step 110, the input value x is updated by multiplying the parameter xb(2), and the output value y is updated by subtracting ln(xb(2)), that is, x=x*xb(2) and y=y−ln(xb(2)).

Because the above parameters xa(2) and xb(2) satisfy the conditions of 1−2\hat{ }(−2) and 1+2\hat{ }(−2) respectively, the calculation x*xa(2) in Step 108 can be implemented by a shift register and an adder in a circuit design, that is, x*xa(2)=x*(1−2\hat{ }(−2))=x−x>>2. Similarly, the calculation x*xb(2) in Step 110 can be implemented by a shift register and an adder in a circuit design, that is, x*xb(2)=x*(1+2\hat{ }(−2))=x+x>>2.

Then, the third iteration operation, the fourth iteration operation, . . . , are executed until a predetermined value of the system, for example, after the eighth iteration operation is completed, the calculated output value y is used as a final calculation result, that is, the logarithm calculation result of the initial input value.

In one embodiment, the parameters xa(i), xb(i), limit_up(i), limit_low(i) used in each iteration operation are designed as shown in Table 1 and Table 2.

TABLE 1

| i | xa(i) | xb(i) |
|---|---|---|
| 1 | 1/2 | 3/2 |
| 2 | 3/4 | 5/4 |
| 3 | 7/8 | 9/8 |
| 4 | 15/16 | 17/16 |
| 5 | 31/32 | 33/32 |
| 6 | 63/64 | 65/64 |
| 7 | 127/128 | 129/128 |
| 8 | 255/256 | 257/256 |
| 9 | 511/512 | 513/512 |
| 10 | 1023/1024 | 1025/1024 |
| 11 | 2047/2048 | 2049/2048 |
| 12 | 4095/4096 | 4097/4096 |
| 13 | 8191/8192 | 8193/8192 |
| 14 | 16383/16384 | 16385/16384 |
| 15 | 32767/32768 | 32769/32768 |
| 16 | 65535/65536 | 65537/65536 |

TABLE 2

| i | limit_up(i) | limit_low(i) |
|---|---|---|
| 1 | 4/3 | 4/5 |
| 2 | 8/7 | 8/9 |
| 3 | 16/15 | 16/17 |
| 4 | 32/31 | 32/33 |
| 5 | 64/63 | 64/65 |
| 6 | 128/127 | 128/129 |
| 7 | 256/255 | 256/257 |
| 8 | 512/511 | 512/513 |
| 9 | 1024/1023 | 1024/1025 |
| 10 | 2048/2047 | 2048/2049 |
| 11 | 4096/4095 | 4096/4097 |
| 12 | 8192/8191 | 8192/8193 |
| 13 | 16384/16383 | 16384/16385 |
| 14 | 32768/32767 | 32768/32769 |
| 15 | 65536/65535 | 65536/65537 |
| 16 | 131072/131071 | 131072/131073 |

By using the parameters of the above table, the input value x after the first iteration operation is between (2/3) and (4/3), the input value x after the second iteration operation is between (5/6) and (8/7), the input value x after the third iteration operation is between (14/15) and (16/15), the input value x after the fourth iteration operation is between (30/31) and (32/31), and the input value x after the fifth iteration operation is between (62/63) and (64/63), the input value x after the sixth iteration operation is between (126/127) and (128/127), . . . , and so on. That is, as the number of the iteration operations increases, the value of the input value x will approach one, thus making the output value y closer to the ideal value. In an example, if sixteen iteration operations are performed, the error between the output value y and the ideal value is 7.6*10\hat{ }(−6).

As mentioned in the above table, since the parameters xa(i) and xb(i) satisfy the conditions of 1−2\hat{ }(−i) and 1+2\hat{ }(−i), the calculation of the input value x can be implemented by a shift register and an adder for each iteration operation. In addition, since the parameters xa(i), xb(i), limit_up(i), and limit_low(i) are all constants, the logarithmic values of these parameters can be calculated in advance for establishing a lookup table, for use of the calculation of the output value y in each iteration operation, that is, the calculation of the output value y in each iteration operation can be implemented by only one adder. In summary, each iteration operation requires only one shift operation, two addition operations and two comparison operations. Therefore, the complexity in the logarithm calculation process can be effectively reduced, and the manufacturing and design costs of the circuit can also be reduced.

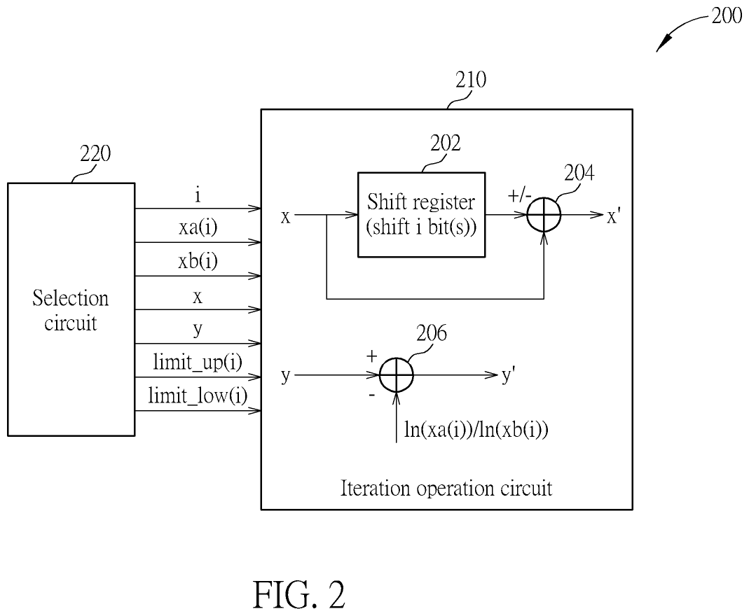

FIG. 2 is a diagram illustrating a logarithm calculation circuit 200 according to one embodiment of the present invention. As shown in FIG. 2, the logarithm calculation circuit 200 includes an iteration operation circuit 210 and a selection circuit 220, wherein the iteration operation circuit 210 is used to perform each iteration operation shown in FIG. 1, and the selection circuit 220 is to provided related parameters to the iteration operation circuit 210 according to the i-th iteration operation currently performed, such as i, xa(i), xb(i), limit_up(i), limit_low(i) mentioned above, and the current input value x and output value y. In the operation of the iteration operation circuit 210 in this embodiment, the iteration operation circuit 210 includes a shift register 202 and two adders 204 and 206, wherein the shift register 202 and the adder 204 are used to perform operations on the input value x in Steps 108 and 110, that is, x=x*xa(i) or x=x*xb(i), where the symbol x′ shown in FIG. 2 is used to represent the input value x for the next iteration operation of the iteration operation circuit 210; and the adder 206 is used to perform operations on the output value y in Steps 108 and 110, that is, y=y−ln(xa(i)) or y=y−ln(xb(i)), where the symbol y′ shown in FIG. 2 is used to represent the output value y for the next iteration operation of the iteration operation circuit 210. Since a person skilled in the art can easily understand the operation of the logarithm calculation circuit 200 after reading the flow shown in FIG. 1, the details of the operation of the logarithm calculation circuit 200 are omitted here.

Briefly summarized, in the logarithm calculation method and related circuits of the present invention, by designing special parameters and iteration operations, each iteration operation can be achieved through only one shift register and two adders. Therefore, the complexity in the logarithm calculation process can be effectively reduced, and the manufacturing and design costs of the circuit can also be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A logarithm calculation method for performing a logarithm operation on an initial input value, comprising:
(a) selecting a first parameter, a second parameter, a third parameter and a fourth parameter corresponding to an i-th iteration operation;
(b) determining whether an input value is greater than the third parameter, or smaller than the fourth parameter, or between the third parameter and the fourth parameter, wherein the input value is obtained by the initial input value;
(c) if the input value is greater than the third parameter, updating the input value by multiplying the first parameter, and updating an output value by subtracting a logarithmic value of the first parameter; if the input value is less than the fourth parameter, updating the input value by multiplying the second parameter, and updating the output value by subtracting a logarithmic value of the second parameter; and if the input number is between the third parameter and the fourth parameter, not changing the input value and output value;
(d) adding one to the value ‘i’ and return to step (a) until the value ‘i’ is equal to a predetermined value; and
(e) when the value ‘i’ is equal to the predetermined value, using the current output value as a calculation result of the logarithm operation of the initial input value.

2. The logarithm calculation method of claim 1, wherein when the value ‘i’ is equal to one, the first parameter, the second parameter, the third parameter and the fourth parameter are (1/2), (3/2), (4/3), (4/5), respectively; when the value ‘i’ is equal to two, the first parameter, the second parameter, the third parameter and the fourth parameter are (3/4), (5/4), (8/7), (8/9), respectively; when the value ‘i’ is equal to three, the first parameter, the second parameter, the third parameter and the fourth parameter are (7/8), (9/8), (16/15), (16/17), respectively; and when the value ‘i’ is equal to four, the first parameter, the second parameter, the third parameter and the fourth parameter are (15/16), (17/16), (32/31), (32/33), respectively.

3. The logarithm calculation method of claim 1, wherein the third parameter is greater than the fourth parameter, the first parameter is 1−2\hat{ }(−i), and the second parameter is 1+2\hat{ }(−i).

4. The logarithm calculation method of claim 3, wherein in the step (c), the operation of updating the input value and the output value is completed by only using shift register(s) and the adder(s).

5. The logarithm calculation method of claim 4, wherein in the step (c), the operation of updating the input value is completed by only using shift register(s) and one adder, and the operation of updating the output value is completed by only using one adder.

6. A logarithm calculation circuit for performing a logarithm operation on an initial input value, comprising:
an iteration operation circuit, for performing multiple iteration operations in sequence;
wherein for any iteration operation performed by the iteration operation circuit, the iteration operation circuit performs the following operations: (a) selecting a first parameter, a second parameter, a third parameter and a fourth parameter corresponding to an i-th iteration operation; (b) determining whether an input value is greater than the third parameter, or smaller than the fourth parameter, or between the third parameter and the fourth parameter, wherein the input value is obtained by the initial input value; (c) if the input value is greater than the third parameter, updating the input value by multiplying the first parameter, and updating an output value by subtracting a logarithmic value of the first parameter; if the input value is less than the fourth parameter, updating the input value by multiplying the second parameter, and updating the output value by subtracting a logarithmic value of the second parameter; and if the input number is between the third parameter and the fourth parameter, not changing the input value and output value; (d) using the updated input value and the updated output value as the input value and the output value of the next iteration operation;
wherein the output value generated by the last iteration operation of the iteration operation circuit is used as a calculation result of the logarithm operation of the initial input value.

7. The logarithm calculation circuit of claim 6, wherein for a first iteration operation of the multiple iteration operations, the first parameter, the second parameter, the third parameter and the fourth parameter are (1/2), (3/2), (4/3), (4/5), respectively; for a second iteration operation of the multiple iteration operations, the first parameter, the second parameter, the third parameter and the fourth parameter are (3/4), (5/4), (8/7), (8/9), respectively; for a third iteration operation of the multiple iteration operations, the first parameter, the second parameter, the third parameter and the fourth parameter are (7/8), (9/8), (16/15), (16/17), respectively; and for a fourth iteration operation of the multiple iteration operations, the first parameter, the second parameter, the third parameter and the fourth parameter are (15/16), (17/16), (32/31), (32/33), respectively.

8. The logarithm calculation circuit of claim 6, wherein the third parameter is greater than the fourth parameter, the first parameter is 1−2\hat{ }(−i), and the second parameter is 1+2\hat{ }(−i).

9. The logarithm calculation circuit of claim 8, wherein the iteration operation circuit only uses shift register(s) and the adder(s) to complete the operation of updating the input value and updating the output value.

10. The logarithm calculation circuit of claim 9, wherein the iteration operation circuit only uses shift register(s) and one adder to complete the operation of updating the input value, and the iteration operation circuit only uses one adder to complete the operation of updating the output value.
